(19) United States
(12) Patent Application Publication
(10) Pub. No.: US 2011/0162674 A1
(43) Pub. Date: Jul. 7, 2011

(54) IN-SITU PROCESS CHAMBER CLEAN TO REMOVE TITANIUM NITRIDE ETCH BY-PRODUCTS

(75) Inventors: HAIRONG TANG, Sunnyvale, CA (US); ALLEN ZHAO, Mountain View, CA (US); NANCY FUNG, Livermore, CA (US)

(73) Assignee: APPLIED MATERIALS, INC., Santa Clara, CA (US)

(21) Appl. No.: 12/884,620

(22) Filed: Sep. 17, 2010

Related U.S. Application Data
(60) Provisional application No. 61/254,821, filed on Oct. 26, 2009.

(51) Int. Cl. B08B 7/00

(52) U.S. Cl. 134/1.1

(57) ABSTRACT

Methods for removing titanium nitride etch by-products from process chambers are provided herein. In some embodiments, a method for the removal of titanium nitride hard mask etch by-products from a process chamber includes processing a substrate having a titanium nitride hard mask. A plasma is then formed from a cleaning gas comprising a chlorine (Cl₂) containing gas in the process chamber to remove at least some of the residual titanium nitride etch by-products. In some embodiments, a method for removing titanium nitride etch by-products from process chambers includes a computer readable medium, having instructions stored thereon which, when executed by a controller, causes a process chamber having a substrate comprising a titanium nitride hard mask to be processed. A plasma is then formed from a cleaning gas comprising a chlorine containing gas in the process chamber to remove the residual titanium nitride etch by-products.

### CROSS-REFERENCE TO RELATED APPLICATIONS

This application claims benefit of U.S. provisional patent application Ser. No. 61/254,821, filed Oct. 26, 2009, which is herein incorporated by reference.

### FIELD

Embodiments of the present invention generally relate to substrate processing.

### BACKGROUND

Integrated circuits have evolved into complex devices that can include millions of components (e.g., transistors, capacitors and resistors) on a single chip. The evolution of chip designs continually requires faster circuitry and greater circuit density. The demands for greater circuit density necessitate a reduction in the dimensions of the integrated circuit components.

The overall size of the integrated circuit components are limited by the smallest geometrical feature that can be etched into a substrate, known as the critical dimension (CD). One technique for etching dielectric layers on substrates to facilitate greater control of the critical dimension utilizes a hard mask, such as a titanium nitride hard mask. Titanium nitride can be used as a hard mask material because it provides high selectivity between the hard mask and the dielectric layer, thereby facilitating control of the critical dimension, while removing the need for an ash step after the trench etch step, thereby reducing the risk of damage to the dielectric layer and preserving k-value integrity while also providing adequate protection of the underlying substrate layer. As a result of the titanium nitride hard mask etching process, residual etch by-products (e.g., TiFₓ, TiOₓ) remain on the surfaces of the process chamber. In subsequent processes performed in the process chamber the residual etch by-products often result in contamination of the substrate and/or a drift in the etch rate. This reduces efficiency of the process, lowering the mean time between clean (MTBC) of the chamber, resulting in more frequent and extended shut down of the process chamber for cleaning.

### SUMMARY

Methods for removing titanium nitride etch by-products from process chambers are provided herein. In some embodiments, a method for the removal of titanium nitride hard mask etch by-products from a process chamber includes processing a substrate having a titanium nitride hard mask causing titanium nitride residues to be deposited on surfaces of the process chamber. A plasma is then formed from a cleaning gas comprising a chlorine (Cl₂) containing gas in the process chamber to remove at least some of the residues.

In some embodiments, a method for removing titanium nitride etch by-products from process chambers includes a computer readable medium, having instructions stored thereon which, when executed by a controller, causes a process chamber having a substrate comprising of a titanium nitride hard mask to be processed, causing titanium nitride residues to be deposited on surfaces of the process chamber. A plasma is then formed from a cleaning gas comprising a chlorine containing gas in the process chamber to remove at least some of the residues.

Other and further embodiments are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only exemplary embodiments of this invention and are therefore not to be considered limiting of its scope, for the invention may admit to other equally effective embodiments.

FIG. 1 is a flow chart depicting a process for performing an in-situ process chamber clean in accordance with some embodiments of the invention.

FIGS. 2A-B depict methods of performing an in-situ process chamber clean in accordance with some embodiments of the invention.

FIG. 3 depicts a process chamber suitable for use in connection with some embodiments of the invention.

The figures are not drawn to scale and may be simplified for clarity. To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to methods for removing by-products of titanium nitride hard mask etching processes. The inventive methods may advantageously increase productivity (e.g. may increase mean time between coincidence, or MTBC) and efficiency of processing substrates by removing residual titanium nitride hard mask etching by-products in-situ, thereby eliminating the need for extended process chamber shut downs for maintenance.

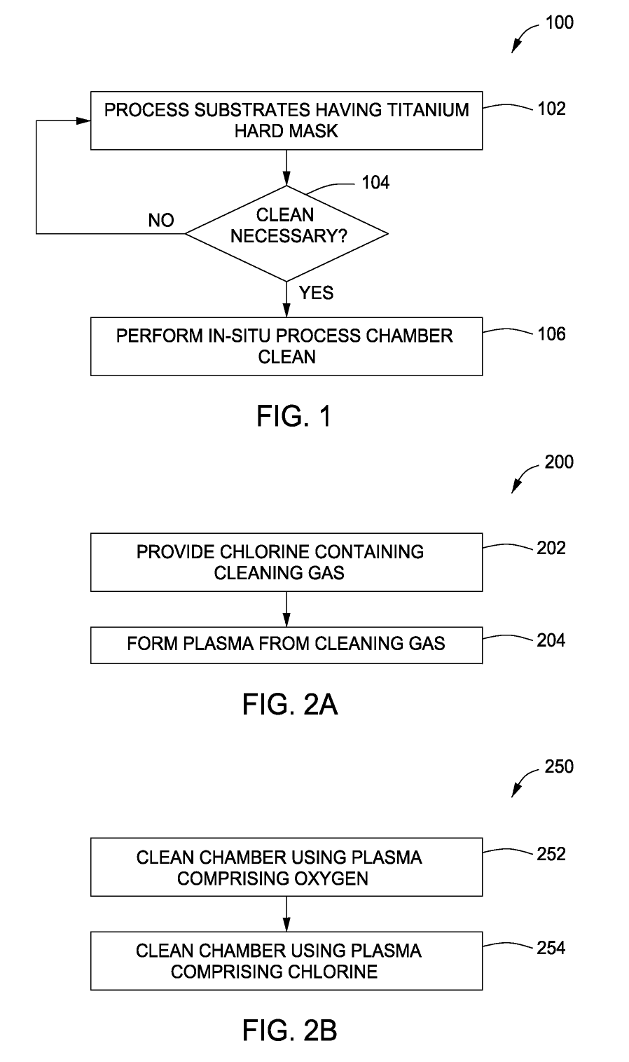

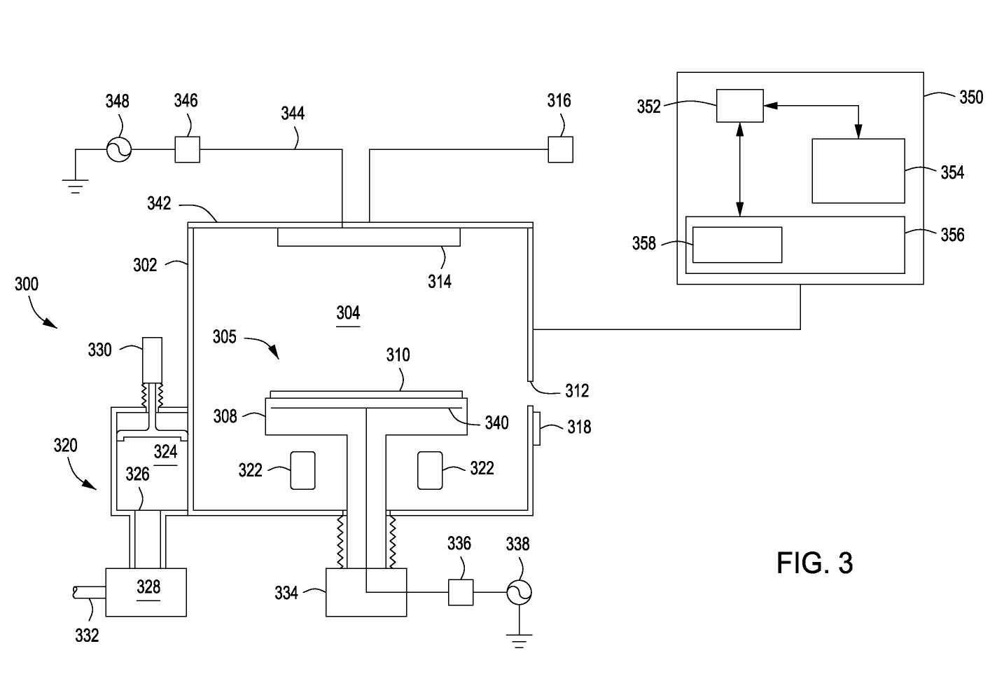

FIG. 1 is a flow chart depicting a process 100 for performing an in-situ process chamber clean in accordance with some embodiments of the invention. FIG. 3 depicts a process chamber suitable for use in connection with some embodiments of the invention, such as described below with respect to FIG. 1.

The process 100 begins at 102, where a substrate 310 having a titanium nitride hard mask is processed a process chamber 302. The substrate 310 may be any suitable substrate, such as a silicon substrate, a III-V compound substrate, a silicon germanium (SiGe) substrate, an epi-substrate, a silicon-on-insulator (SOI) substrate, a display substrate such as a liquid crystal display (LCD), a plasma display, an electro luminescence (EL) lamp display, a light emitting diode (LED) substrate, a solar cell array, solar panel, or the like. In some embodiments, the substrate 310 may be a semiconductor wafer (e.g., a 200 mm, 300 mm, or the like silicon wafer). As a result of processing the substrate (for example, etching through the titanium nitride hard mask, or removing the titanium nitride hard mask), a residue comprising titanium and/or nitrogen may form on the walls of the process chamber and/or other components disposed within the process chamber (such as TiFₓ, TiOₓ, or the like). Although discussed above with respect to processing a substrate having a titanium nitride hard mask, the present inventive techniques are generally applicable to cleaning process chambers having residues from processing titanium nitride regardless of the use of the titanium nitride material.

Next, at 104, a decision may be made whether or not to perform the in-situ process chamber clean 106. The decision to perform the in-situ process chamber clean 106 may be made at any time during production, such as based upon actual time elapsed between process chamber cleans, equipment runtime elapsed, prior to introducing the first wafer into the equipment, between processing each wafer in the equipment, between processing a predetermined number of wafers, between processing wafer lots in the equipment, shift-to-shift changes of operators, between making changes in the process conditions in the equipment, after any other maintenance of the equipment, or at any other time deemed desirable. The decision at 104 may be made automatically and/or run manually (e.g., invoked by the operator) at any suitable or desirable time, such as during equipment idle time. The decision to perform the in situ chamber clean may be based upon accumulation of residue upon the chamber walls and/or other components that may rise to a level of risk of undesirable effects such as flaking off of particles, contamination of the substrate, non-uniformity or drift of process results, or the like. If a decision is made not to perform the in-situ process chamber clean 106, the process returns to 102 and processing of subsequent substrates may continue.

If the decision is made to perform the in-situ process chamber clean at 106, a method for performing the in-situ process chamber clean begins. In some embodiments, for example, the residue from processing the titanium nitride hard mask may be difficult to remove using conventional plasma cleaning techniques. In such cases, an in situ chamber clean process in accordance with embodiments of the present invention may be performed. For example, FIG. 2A depicts a method 200 for performing an in-situ process chamber clean in accordance with some embodiments of the invention and suitable for use at 106. The method 200 generally begins at 202, where a chlorine containing cleaning gas is provided to the process chamber 302. The chlorine containing cleaning gas may be provided via a gas supply 316 connected to an internal shower head 314, as depicted in FIG. 3. In some embodiments, the showerhead 314 may alternatively or in combination be any suitable nozzle or gas input sufficient to provide gas to the process chamber 302. The inventors have discovered that a plasma cleaning process using a chlorine containing cleaning gas can more aggressively remove the residues resulting from processing titanium nitride materials as compared to conventional plasma cleaning techniques.

In some embodiments, the chlorine containing cleaning gas may comprise a chlorine containing gas. For example, the chlorine containing cleaning gas may comprise at least one of chlorine (Cl₂) gas, hydrogen chloride (HCl) gas, or the like. The chlorine containing cleaning gas may be provided to the process chamber 302 at a flow rate of up to about 200 sccm.

In some embodiments, the chlorine containing cleaning gas may further comprise a chlorine containing gas and an inert gas, such as argon (Ar), nitrogen (N), or the like. The flow rate ratio of the inert gas to the chlorine containing gas may be adjusted to alter the efficiency of the in-situ process chamber clean. For example, such as when the chlorine containing cleaning gas comprises a chlorine containing gas and argon, the flow rate ratio of chlorine containing gas to argon may be between about 1:0 (i.e., about pure Cl₂) to about 3:1. In some embodiments, the flow rate ratio of the chlorine containing gas to argon may be about 1:1. In embodiments such as when the chlorine containing cleaning gas comprises a chlorine containing gas and nitrogen, the flow rate ratio of chlorine containing gas to nitrogen may be the same as above for argon. In some embodiments, the chlorine containing cleaning gas may comprise a chlorine containing gas, argon, and nitrogen with the ratio of chlorine containing gas to the total amount of inert gas provided being within the same range as disclosed above.

Next, at 204, a plasma is formed in the process chamber 302 from the chlorine containing cleaning gas. In some embodiments, sufficient power, such as up to about 700 W of source RF power (for example at a high or very high frequency, such as about 13.56 MHz, or more, or about 162 MHz), is provided to the process chamber 302 to ignite the chlorine containing cleaning gas and form the plasma. Additional process parameters may be utilized to promote plasma ignition and stability. For example, in some embodiments, the process chamber 302 may be maintained at a temperature of between about 0 to about 120 degrees Celsius during plasma ignition and throughout the in-situ process chamber clean. In some embodiments, the substrate support may be maintained at a temperature of about minus 20 and about 60 degrees Celsius. Additionally, in some embodiments, the process chamber 302 may be maintained at a pressure of between about 5 to about 500 mTorr, such as about 50 mTorr.

The in-situ process chamber clean 106, such as depicted in the method 200 of FIG. 2A, may be performed for any length of time determined to be necessary to achieve adequate cleaning of the process chamber 302. For example, this may be a predetermined set time period or may be determined by visual inspection, optical spectrometry, or other suitable process endpoint detection system. In some embodiments, the in-situ process chamber clean 106 may be performed up to about 60 seconds, or in some embodiments, greater than 60 seconds.

In some embodiments, when the decision is made to perform the in-situ process chamber clean at 106, embodiments of the above chamber clean method 200 may be used for each cleaning cycle. However, in some embodiments, for example where the more aggressive chlorine chamber clean is not needed or desired, but a reduction of the accumulated residues is still beneficial, an alternate method for performing the in-situ process chamber clean may be performed. For example, FIG. 2B depicts a method 250 for performing an in-situ process chamber clean in accordance with some embodiments of the invention and suitable for use at 106. The method 250 generally begins at 252, where an oxygen containing cleaning gas is provided to the process chamber 302 to form a cleaning plasma therein (an oxygen cleaning plasma). The oxygen containing cleaning gas may be provided via the gas supply 316. The oxygen cleaning plasma may be formed in a manner known to those of ordinary skill in the art and may be maintained for a suitable duration to at least partially clean the process chamber 302.

After one or more chamber cleans using the oxygen cleaning plasma, an in situ chamber clean using a chlorine containing gas may be provided at 254. The chlorine chamber clean may facilitate more robustly cleaning the process chamber 302. The chlorine chamber clean may be performed as discussed above with respect to the method 200. As an example, chamber cleaning processes may alternately be performed using oxygen and chlorine cleaning gases. Alternatively, a certain amount of chamber cleaning processes may be performed using the oxygen cleaning gases until it is desired to perform the chamber clean using the chlorine cleaning gas. In some embodiments, a chlorine chamber clean may be provided upon the completion of (or prior to the start of) processing a given lot of substrates. with oxygen chamber cleans being performed between each substrate or between some desired number of substrates within the particular lot. The inventors have discovered that in some embodiments, the more aggressive chlorine cleaning chemistry may more aggressively wear chamber components. Thus, using the chlorine chamber clean only when needed can facilitate further increasing uptime of processing equipment.

FIG. 3 depicts an exemplary apparatus 300 in accordance with some embodiments of the present invention. The apparatus 300 may comprise a controller 350 and a process chamber 302 having an exhaust system 320 for removing excess process gases, processing by-products, or the like, from the interior of the process chamber 305. Exemplary process chambers may include the DPS®, ENABLER®, ADVANTEDGE™, or other process chambers, available from Applied Materials, Inc. of Santa Clara, Calif. It is contemplated that other process chambers that accumulate residues from TiN may benefit from the inventive methods disclosed herein.

To facilitate control of the process chamber 302 as described above, the controller 350 may be one of any form of general-purpose computer processor that can be used in an industrial setting for controlling various chambers and sub-processors. The memory, or computer-readable medium, 356 of the CPU 352 may be one or more of readily available memory such as random access memory (RAM), read only memory (ROM), floppy disk, hard disk, or any other form of digital storage, local or remote. The support circuits 354 are coupled to the CPU 352 for supporting the processor in a conventional manner. These circuits include cache, power supplies, clock circuits, input/output circuitry and subsystems, and the like.

The inventive methods 100, 200 are generally stored in the memory 356 as a software routine 358. The software routine 358 may also be stored and/or executed by a second CPU (not shown) that is remotely located from the hardware being controlled by the CPU 352. Some or all of the method of the present invention may also be performed in hardware. As such, the invention may be implemented in software and executed using a computer system, in hardware as, e.g., an application specific integrated circuit or other type of hardware implementation, or as a combination of software and hardware. The software routine 358, when executed by the CPU 352, causes the process chamber 302 to perform processes of the present invention and is generally stored in the memory 356. The software routine 358 may also be stored and/or executed by a second CPU (not shown) that is remotely located from the hardware being controlled by the CPU 352.

The software routine 358, when executed by the CPU 352, transforms the general purpose computer into a specific purpose computer (controller) 350 that controls the chamber operation such that the in-situ process chamber clean is performed. Although the process of the present invention is discussed as being implemented as a software routine, some of the method that are disclosed therein may be performed in hardware as well as by the software controller. As such, the invention may be implemented in software as executed upon a computer system, in hardware as an application specific integrated circuit or other type of hardware implementation, or a combination of software and hardware.

The process chamber 302 has an inner volume 305 that may include a processing volume 304. The processing volume 304 may be defined, for example, between a substrate support 308 disposed within the process chamber 302 for supporting a substrate 310 thereupon during processing and one or more gas inlets, such as a showerhead 314 and/or nozzles provided at desired locations. In some embodiments, the substrate support 308 may include a mechanism that retains or supports the substrate 310 on the surface of the substrate support 308, such as an electrostatic chuck, a vacuum chuck, a substrate retaining clamp, or the like (not shown). In some embodiments, the substrate support 308 may include mechanisms for controlling the substrate temperature (such as heating and/or cooling devices, not shown) and/or for controlling the species flux and/or ion energy proximate the substrate surface.

For example, in some embodiments, the substrate support 308 may include an RF bias electrode 340. The RF bias electrode 340 may be coupled to one or more bias power sources (one bias power source 338 shown) through one or more respective matching networks (matching network 336 shown). The one or more bias power sources may be capable of producing up to 3000 W at a frequency of about 2 MHz, or about 13.56 MHz, or about 60 MHz. In some embodiments, two bias power sources may provided at frequencies of about 2 MHz and about 13.56 MHz. The at least one bias power source may provide either continuous or pulsed power. In some embodiments, the bias power source may be a DC or pulsed DC source.

The substrate 310 may enter the process chamber 302 via an opening 312 in a wall of the process chamber 302. The opening 312 may be selectively sealed via a slit valve 318, or other mechanism for selectively providing access to the interior of the chamber through the opening 312. The substrate support 308 may be coupled to a lift mechanism 334 that may control the position of the substrate support 308 between a lower position (as shown) suitable for transferring substrates into and out of the chamber via the opening 312 and a selectable upper position suitable for processing. The process position may be selected to maximize process uniformity for a particular process. When in at least one of the elevated processing positions, the substrate support 308 may be disposed above the opening 312 to provide a symmetrical processing region.

The one or more gas inlets (e.g., the showerhead 314) may be coupled to a gas supply 316 for providing one or more process gases into the processing volume 304 of the process chamber 302. Although a showerhead 314 is shown in FIG. 3, additional or alternative gas inlets may be provided such as nozzles or inlets disposed in the ceiling or on the sidewalls of the process chamber 302 or at other locations suitable for providing gases as desired to the process chamber 302, such as the base of the process chamber, the periphery of the substrate support, or the like.

In some embodiments, the apparatus 300 may utilize inductively coupled RF power for processing. For example, the process chamber 302 may have a ceiling 342 and showerhead 314 made from a dielectric material. The ceiling 342 may be substantially flat, although other types of ceilings, such as dome-shaped ceilings or the like, may also be utilized. An antenna comprising at least one inductive coil element 344 is disposed above the ceiling 342. The at least one inductive coil element 344 is coupled to one or more RF power sources (one RF power source 348 shown) through one or more respective matching networks (matching network 346 shown). The one or more plasma sources may be capable of producing up to about 2,000 W or more at a frequency of, for example, about 162 MHz.

The exhaust system 320 generally includes a pumping plenum 324 and a plurality of conduits that couple the pumping plenum 324 to the inner volume 305 (and generally, the processing volume 304) of the process chamber 302.

Each conduit has an inlet 322 coupled to the inner volume 305 (or, in some embodiments, the exhaust volume 306) and an outlet (not shown) fluidly coupled to the pumping plenum 324. For example, each conduit may have an inlet 322 disposed in a lower region of a sidewall or a floor of the process chamber 302. In some embodiments, the inlets are substantially equidistantly spaced from each other.

A vacuum pump 328 may be coupled to the pumping plenum 324 via a pumping port 326 for pumping out the exhaust gases from the process chamber 302. The vacuum pump 328 may be fluidly coupled to an exhaust outlet 332 for routing the exhaust as required to appropriate exhaust handling equipment. A valve 330 (such as a gate valve, or the like) may be disposed in the pumping plenum 324 to facilitate control of the flow rate of the exhaust gases in combination with the operation of the vacuum pump 328. Although a z-motion gate valve is shown, any suitable, process compatible valve for controlling the flow of the exhaust may be utilized.

The exhaust system 320 facilitates uniform flow of the exhaust gases from the inner volume 305 of the process chamber 302. For example, the exhaust system 320 may provide at least one of reduced variance of flow resistance azimuthally (or symmetrically) about the substrate support 308 (e.g., substantially equal flow resistance), or substantially equal residence time for the exhaust flow to the pump. Accordingly, in some embodiments, the plurality of conduits may have a substantially equal conductance. As used herein, the term substantially equivalent, or substantially equal, means within about 10 percent of each other). The terms substantially equivalent or substantially equal, as defined above, may be used to describe other aspects of the invention, such as conduit length, flow length, cross-sectional area, or the like, as described in more detail below. In some embodiments, the plurality of conduits may have a high conductance, or a high conductance as compared to the pump speed. The conductance may be controlled by the combination of the conductivity of the medium through which the exhaust gases may be exhausted (e.g., such as atmospheric or vacuum conditions), the flow length of the conduit (e.g., a distance of the mean flow path between each inlet and the pumping port), and the cross-sectional area of the conduit along the flow length.

In some embodiments, the plurality of conduits may have a substantially equal flow length. In some embodiments, the plurality of conduits may have a substantially equal cross-sectional area along an equivalent position there along (e.g., the cross-sectional area may vary along the length of each conduit, but each conduit in the plurality will vary in a substantially equivalent manner). In some embodiments, the plurality of conduits may be symmetrically arranged about the process chamber. In some embodiments, the plurality of conduits may be symmetrically arranged about a vertical plane passing through pumping port 326 and the substrate support 308 of the process chamber 302.

While the foregoing is directed to embodiments of the present invention, other and further embodiments of the invention may be devised without departing from the basic scope thereof.

1. A method for the removal of titanium nitride etch by-products from a process chamber, comprising:
processing a substrate having a titanium nitride layer in a process chamber causing titanium nitride residues to be deposited on surfaces of the process chamber; and
cleaning the process chamber with a plasma formed from a cleaning gas comprising a chlorine containing gas to remove at least some of the residues.

2. The method of claim 1, wherein the chlorine containing gas comprises at least one of chlorine (Cl₂) or hydrogen chloride (HCl).

3. The method of claim 1, wherein the chlorine containing gas is provided at a flow rate of up to about 200 sccm.

4. The method of claim 1, wherein the chlorine containing gas further comprises argon.

5. The method of claim 4, wherein a flow rate ratio of the chlorine containing gas to argon is between about 1:0 to about 3:1

6. The method of claim 4, wherein a flow rate ratio of the chlorine containing gas to argon is about 1:1.

7. The method of claim 1, wherein the chlorine containing gas further comprises nitrogen.

8. The method of claim 1, wherein the chlorine containing gas further comprises argon and nitrogen.

9. The method of claim 1, wherein forming the plasma further comprises: maintaining the process chamber at a pressure between about 5 to about 500 mTorr.

10. The method of claim 1, wherein forming the plasma further comprises:
maintaining the process chamber at a pressure of about 50 mTorr.

11. The method of claim 1, wherein forming the plasma further comprises:
providing up to about 700 W of source RF power.

12. The method of claim 1, wherein forming the plasma further comprises:
maintaining the process chamber at a temperature between about 0 degrees Celsius to about 120 degrees Celsius.

13. The method of claim 1, further comprising:
sequentially processing a plurality of substrates having a titanium nitride layer in the process chamber causing titanium nitride residues to be deposited on surfaces of the process chamber; and
cleaning the process chamber with a plasma formed from a cleaning gas comprising oxygen to remove at least some of the residues after processing at least one of the plurality of substrates.

14. A computer readable medium, having instructions stored thereon which, when executed by a controller, causes the removal of titanium nitride etch by-products from a substrate process chamber by a method, comprising:
processing a substrate having a titanium nitride hard layer in a process chamber causing titanium nitride residues to be deposited on surfaces of the process chamber; and
cleaning the process chamber with a plasma formed from a cleaning gas comprising a chlorine containing gas to remove at least some of the residues.

15. The computer readable medium of claim 14, wherein the chlorine containing gas is provided at a flow rate of up to about 200 sccm.

16. The computer readable medium of claim 14, wherein the chlorine containing gas further comprises at least one of argon or nitrogen.

17. The computer readable medium of claim 14, wherein the chlorine containing gas further comprises argon and wherein a flow rate ratio of the chlorine containing gas to argon is between about 1:0 to about 3:1.

18. The computer readable medium of claim 17, wherein a flow rate ratio of the chlorine containing gas to argon is about 1:1.

19. The computer readable medium of claim 14, wherein forming the plasma further comprises at least one of:
maintaining the process chamber at a pressure between about 5 to about 500 mTorr;
maintaining the process chamber at a temperature between about 0 degrees Celsius to about 120 degrees Celsius; and
providing up to about 700 W of source RF power.

20. The computer readable medium of claim 14, further comprising:
sequentially processing a plurality of substrates having a titanium nitride layer in the process chamber causing titanium nitride residues to be deposited on surfaces of the process chamber; and
cleaning the process chamber with a plasma formed from a cleaning gas comprising oxygen to remove at least some of the residues after processing at least one of the plurality of substrates.
